(19) United States
(12) Patent Application Publication
(10) Pub. No.: US 2025/0353433 A1
(43) Pub. Date: Nov. 20, 2025

(54) VEHICULAR EXTERIOR REARVIEW MIRROR ASSEMBLY WITH EXTENSION/RETRACTION MECHANISM

(71) Applicant: Magna Mirrors of America, Inc., Holland, MI (US)

(72) Inventor: Kenneth C. Peterson, Ada, MI (US)

(21) Appl. No.: 19/207,700

(22) Filed: May 14, 2025

Related U.S. Application Data
(60) Provisional application No. 63/648,899, filed on May 17, 2024.

(51) Int. Cl. B60R 1/07

(52) U.S. Cl. CPC B60R 1/07

(57) ABSTRACT

A vehicular exterior rearview mirror assembly includes a mounting structure configured to mount the vehicular exterior rearview mirror assembly at a side of a vehicle. A mirror head accommodates a mirror reflective element. The mirror head is movable relative to the mounting structure between a retracted position and an extended position. An adjustment mechanism is operable to guide movement of the mirror head relative to the mounting structure. The adjustment mechanism includes a pivot link having a first end pivotally attached at the mirror head and a second end pivotally attached at the mounting structure. When the mirror head moves from the retracted position toward the extended position, the second end pivots relative to the mounting structure, the first end pivots relative to and the first end moves with the mirror head at least partially in a direction away from the side of the vehicle and at least partially vertically.

### CROSS REFERENCE TO RELATED APPLICATION

The present application claims the filing benefits of U.S. provisional application Ser. No. 63/648,899, filed May 17, 2024, which is hereby incorporated herein by reference in its entirety.

### FIELD OF THE INVENTION

The present invention relates generally to the field of exterior rearview mirror assemblies for vehicles and, more particularly, to extendable and retractable exterior rearview mirror assemblies for vehicles.

### BACKGROUND OF THE INVENTION

It is known to provide an automotive exterior rearview mirror assembly that may be extended and retracted, such as for trailer towing applications, where the mirror assembly may be extended to provide enhanced rearward viewing to the driver of the trailer pulling vehicle. Examples of extendable and retractable mirror assemblies are described in U.S. Pat. Nos. 5,483,385; 6,116,743; 6,213,609; 6,239,928; 6,276,808; 6,325,518; 6,394,616 and/or 6,497,491, which are hereby incorporated herein by reference in their entireties.

### SUMMARY OF THE INVENTION

A vehicular exterior rearview mirror assembly includes a mounting structure configured to mount the vehicular exterior rearview mirror assembly at a side of a vehicle, and a mirror head accommodating a mirror reflective element. With the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position where the mirror head is extended from the retracted position outward from the side of the vehicle to provide the rearward view to the driver of the vehicle. The mirror head is closer to the side of the vehicle at which the mounting structure is attached when in the retracted position as compared to the extended position. An adjustment mechanism is operable to guide movement of the mirror head relative to the mounting structure between the retracted position and the extended position. The adjustment mechanism includes a pivot link, and the pivot link includes (i) a first end pivotally attached at the mirror head and (ii) a second end pivotally attached at the mounting structure. With the vehicular exterior rearview mirror assembly mounted at the side of the vehicle, and when the mirror head is moved between the retracted position and the extended position, the second end of the pivot link pivots relative to the mounting structure and the first end of the pivot link moves with the mirror head (i) at least partially in a direction parallel to a longitudinal axis of the mounting structure and (ii) at least partially vertical relative to the mounting structure.

These and other objects, advantages, purposes and features of the present invention will become apparent upon review of the following specification in conjunction with the drawings.

### BRIEF DESCRIPTION OF THE DRAWINGS

FIG. 1 is a perspective view of an exterior rearview mirror assembly that pivots about a vertical pivot axis between a retracted state and an extended state;

FIG. 2 is a perspective view of another exterior rearview mirror assembly that pivots about a horizontal pivot axis between the retracted state and the extended state;

FIG. 3A is a perspective view of the exterior rearview mirror assembly of FIG. 2 in the retracted state;

FIG. 3B is a perspective view of the exterior rearview mirror assembly of FIG. 2 in the extended state;

FIG. 4A is a perspective view of a structural member of a mounting arm and pivot links of the exterior rearview mirror assembly of FIG. 2 in the retracted state;

FIG. 4B is a perspective view of the structural member of the mounting arm and pivot links of the exterior rearview mirror assembly of FIG. 2 in the extended state;

FIGS. 5A and 6A are views of the exterior rearview mirror assembly of FIG. 2 in the retracted state;

FIGS. 5B and 6B are views of the exterior rearview mirror assembly of FIG. 2 in the extended state;

FIGS. 7A and 7B are sectional views of the exterior rearview mirror assembly of FIG. 2;

FIGS. 8A and 9A are additional views of the exterior rearview mirror assembly of FIG. 2 in the retracted state;

FIGS. 8B and 9B are additional views of the exterior rearview mirror assembly of FIG. 2 in the extended state;

FIG. 10 is a sectional view of the exterior rearview mirror assembly of FIG. 2 showing the relative position of the mirror reflective element relative to the mounting arm in the retracted state and the extended state;

FIGS. 11 and 12 are schematic views of the exterior rearview mirror assembly of FIG. 2 showing intersecting pivot axes of the pivot links; and

FIG. 13 is an exploded view of the exterior rearview mirror assembly of FIG. 2.

### DESCRIPTION OF THE PREFERRED EMBODIMENTS

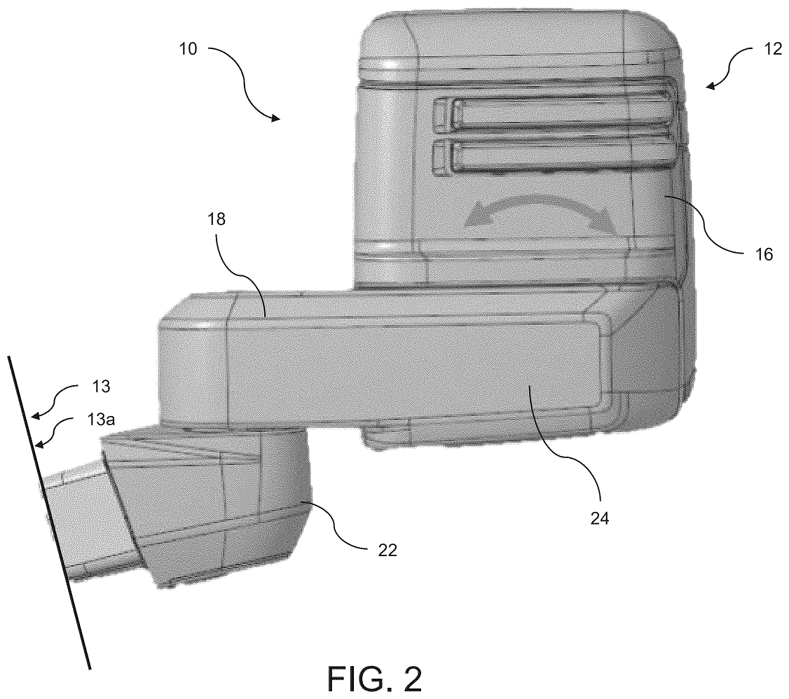

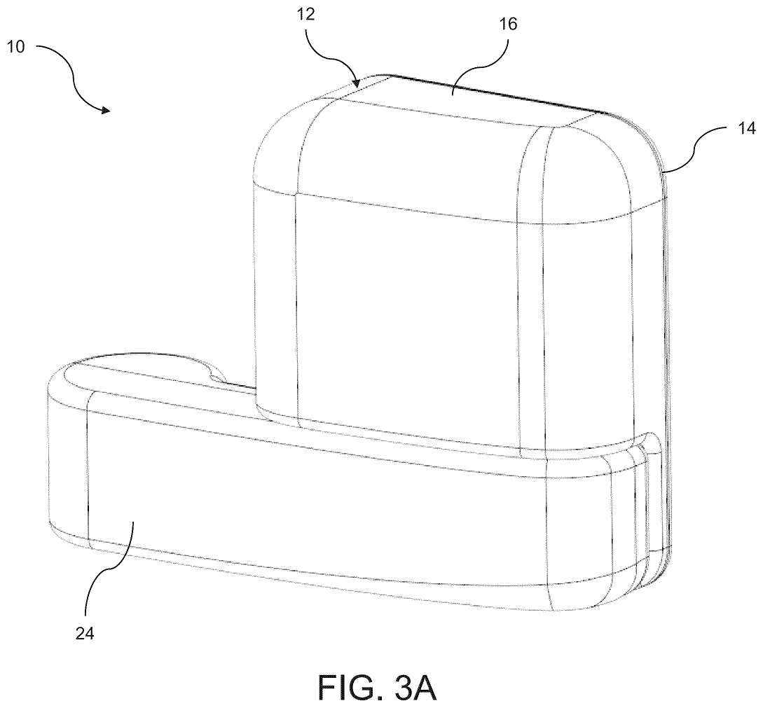

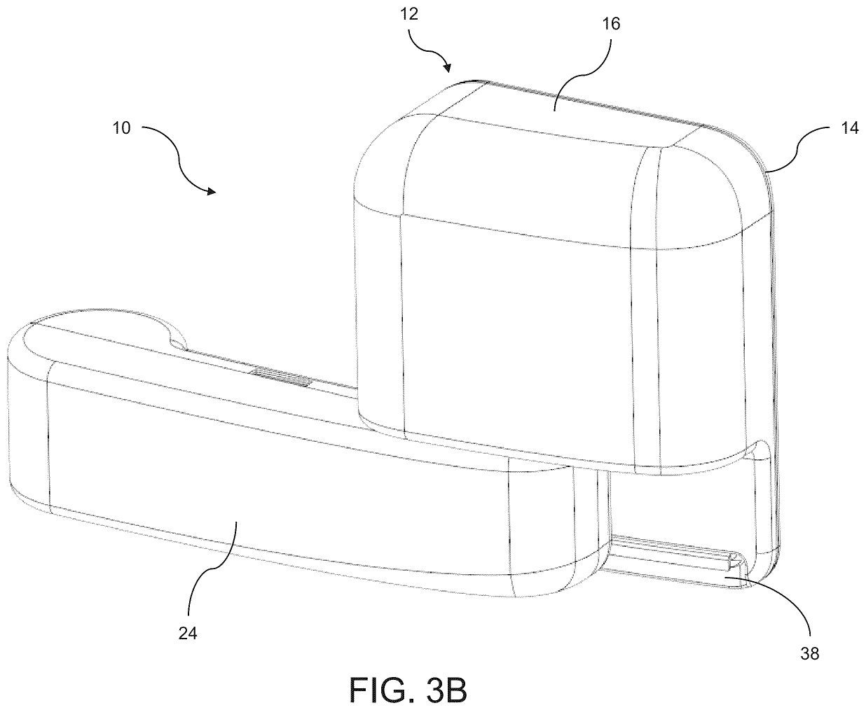

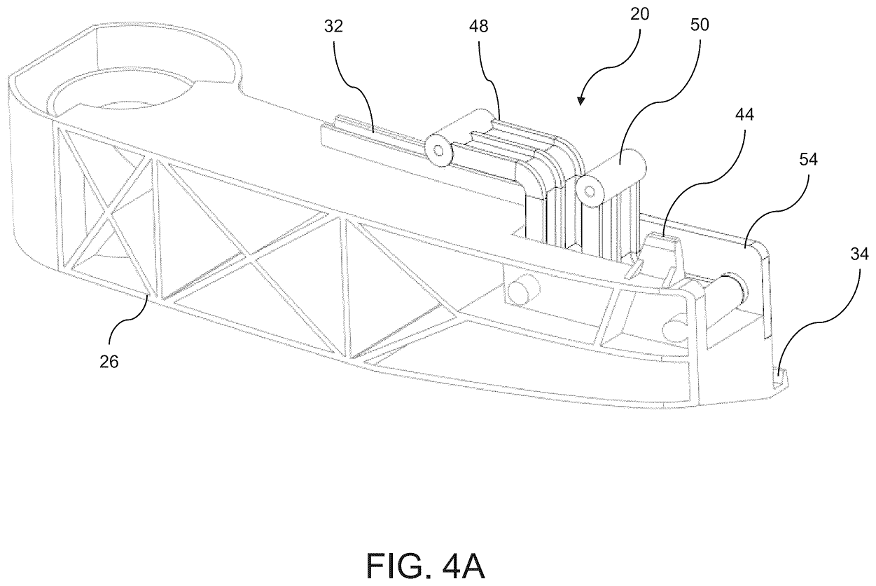

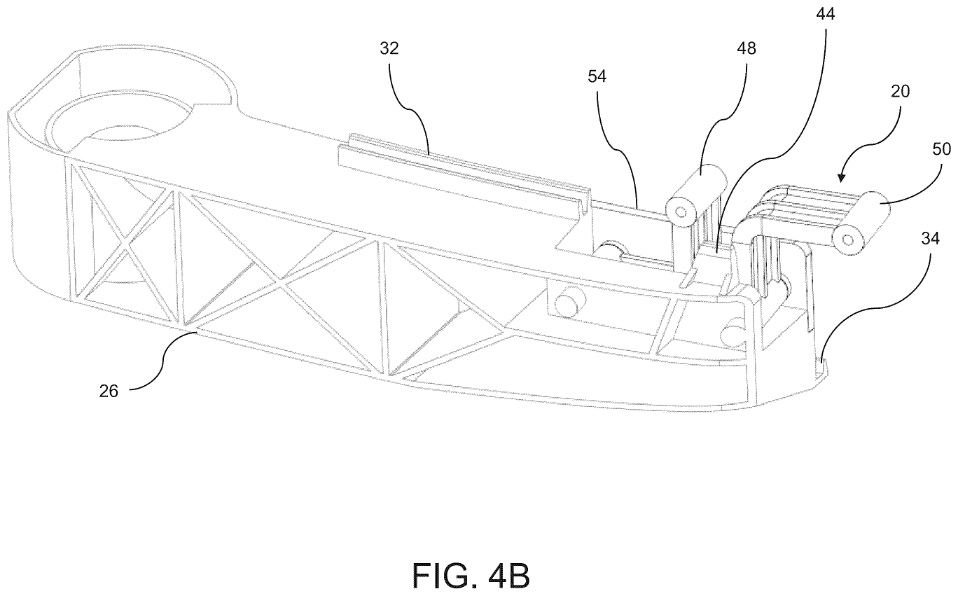

Referring now to the drawings and the illustrative embodiments depicted therein, an exterior rearview mirror assembly 10 for a vehicle 13 includes a mirror head 12 having a mirror reflective element 14 received in and/or supported at or by a mirror shell or casing 16 (FIG. 2). The mirror head 12 may be adjustably mounted at a mounting structure 18 at a side 13a of the vehicle 13 with the mirror assembly 10 adjustable between a use position or deployed position or drive position, where the mirror head 12 is extended from the side of the vehicle to provide a rearward view to a driver of the vehicle, and a non-use position or folded position or park position, where the mirror head 12 is pivoted in toward the side of the vehicle. Further, with the mirror assembly 10 in the use position, the mirror head 12 is adjustable relative to the mounting structure 18 via an adjustment mechanism or device 20 (FIGS. 4A and 4B) operated by an electrically operable actuator (not shown) and that adjusts the mirror head 12 between a retracted state (FIG. 3A) and an extended state (FIG. 3B). For example, at least part of the adjustment mechanism 20 may be housed or accommodated within the mirror head 12 and thus move together and in tandem with the mirror head between the retracted state and the extended state. The mounting structure 18 of the mirror assembly 10 is mounted at the side 13a of the host or subject vehicle 13, with the reflective element 14 providing the rearward field of view along the respective side 13a of the vehicle 13 to the driver of the vehicle. When the mirror head 12 is in the retracted state, the mirror reflective element 14 may provide a first rearward field of view along the side 13a of the vehicle 13 and, when the mirror head 12 is in the extended state, the mirror head 12 is moved from the retracted state further outboard of the side 13a of the vehicle 13 and may provide a second rearward field of view along the side 13a of the vehicle 13, such as a wider field of view that extends further outward from the side 13a of the vehicle 13 than the first field of view. For example, the mirror head 12 may be movable between the retracted state and the extended state responsive to a user input within the vehicle and actuatable by the driver of the vehicle.

The mounting structure 18 includes a base portion 22 that mounts at the side 13a of the vehicle and a mounting arm 24 extending from the base portion 22 to support the mirror head 12 outboard of the side of the vehicle. The mounting structure 18 may enable power folding and/or manual pivoting of the mirror head 12 relative to the side of the vehicle between the folded or park position and the deployed or use position. For example, the arm 24 may be pivotable relative to the base portion 22 to move the mirror head 12 between the folded position and the deployed position, or the base portion 22 or a part of the base portion 22 may be pivotable relative to the side of the vehicle to move the mirror head 12 between the folded position and the deployed position. With the mounting structure 18 extended from the side of the vehicle (i.e., when the mirror head is in the deployed position), the mirror head is adjustable between the retracted state and the extended state via operation of the adjustment mechanism 20 to move the mirror head 12 along the arm 24. The arm 24 may comprise any suitable guiding member, such as a tubular arm, extruded member, and the like.

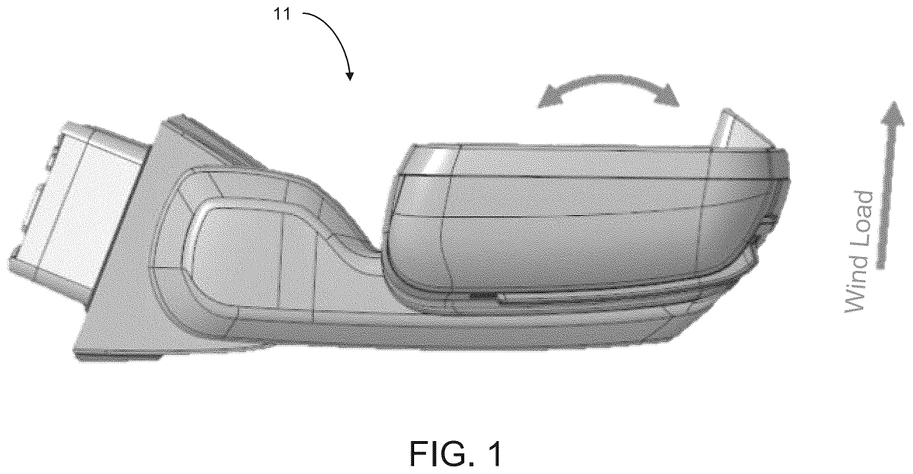

FIG. 1 depicts a mirror assembly 11 where the mirror head moves or swings about a vertical pivot axis (e.g., transverse to the longitudinal axis of the mounting arm and transverse to a longitudinal axis of the vehicle) when moved between the retracted state and the extended state. As shown in FIG. 1, with the mirror assembly 11 in the use position and as the vehicle travels along the road in a forward direction, a wind load is experienced at the mirror head in a direction generally parallel to the longitudinal axis of the vehicle and the wind load urges the mirror head rearward and toward the side of the vehicle. That is, with the mirror head in the use position, the wind load may urge the mirror head relative to the mounting arm about its pivot axis (e.g., from the retracted state toward the extended state or from the extended state toward the retracted state). Thus, the adjustment mechanism (e.g., an electrically operable actuator and links that pivot to move the mirror head between the retracted state and the extended state) may experience a torque load to maintain the mirror head position against the wind load. Further, with the wind load urging the mirror head away from the mounting arm, it is difficult to provide positive engagement between the mirror head and mounting arm in the direction of fore-aft vibration modes. In other words, when movement of the mirror head along the mounting arm between the retracted state and the extended state is at least partially in the direction of the wind load (FIG. 1), engagement between the mirror head and the mounting arm that reduces fore-aft vibrations is limited.

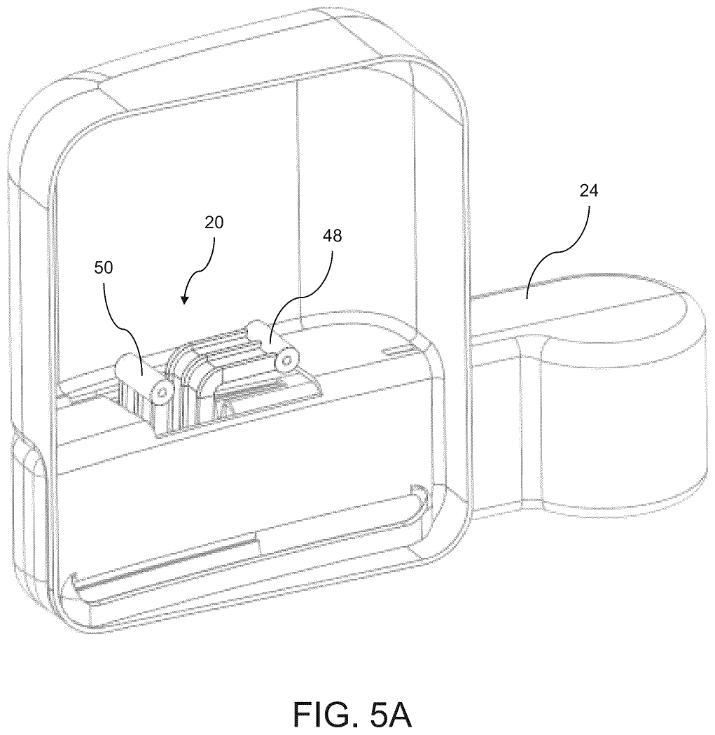

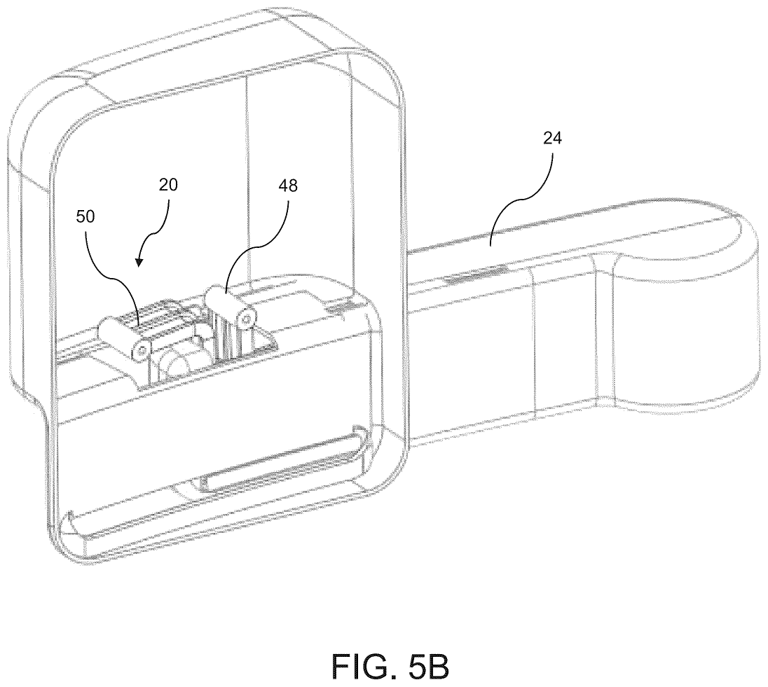

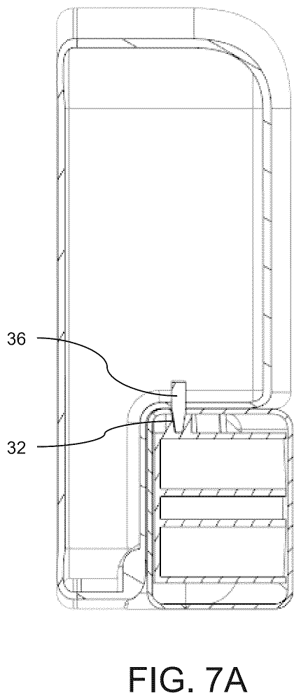

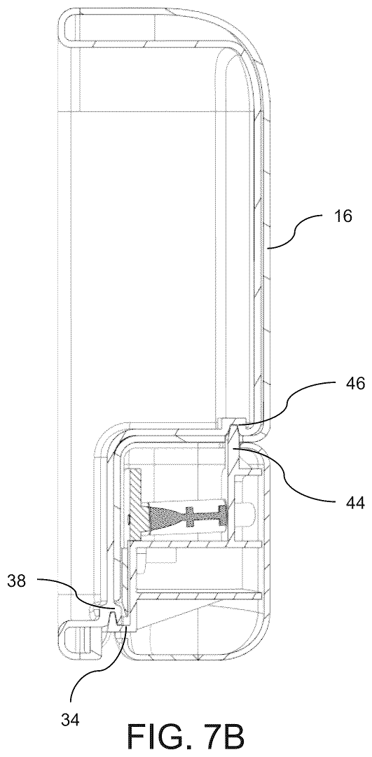

Referring to FIGS. 2-13, and as discussed further below, the adjustment mechanism 20 of the mirror assembly 10 moves or swings the mirror head 12 about a horizontal pivot axis or a pivot axis that is (i) generally transverse to the longitudinal axis of the mounting arm 24 and (ii) generally parallel to the direction of the wind load (e.g., generally parallel to the longitudinal axis of the vehicle) when moving the mirror head 12 between the retracted state and the extended state. In other words, the swing path of the mirror head 12 has a vertical component as the mirror head swings between the retracted state and the extended state. For example, as the mirror head moves from the extended state toward the retracted state, the mirror head moves or swings upward away from the mounting arm 24 and inward along the mounting arm 24 during the first part of the swing path and then downward toward the mounting arm 24 and further inward along the mounting arm 24 during the second part of the swing path. This may make the adjustment mechanism 20 more easily packageable and, because movement of the mirror head 12 may be perpendicular to the wind load, gravity may help to hold the mirror head 12 in contact with the mounting arm 24.

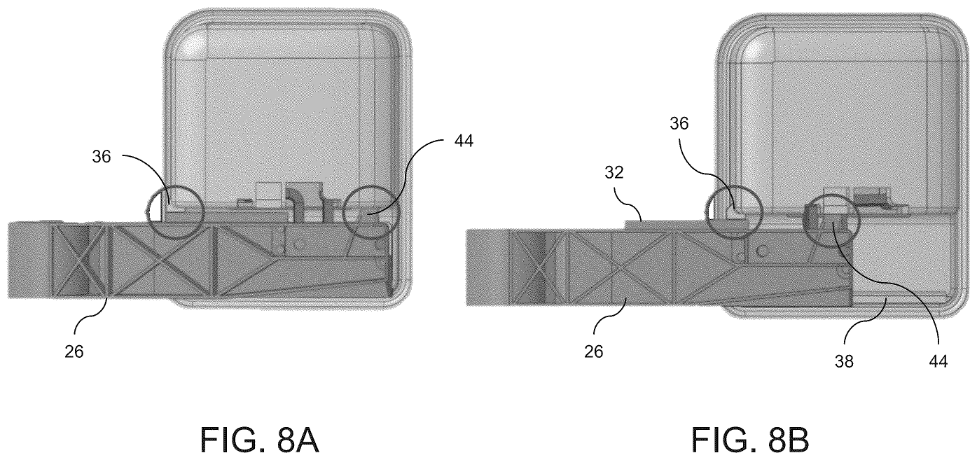

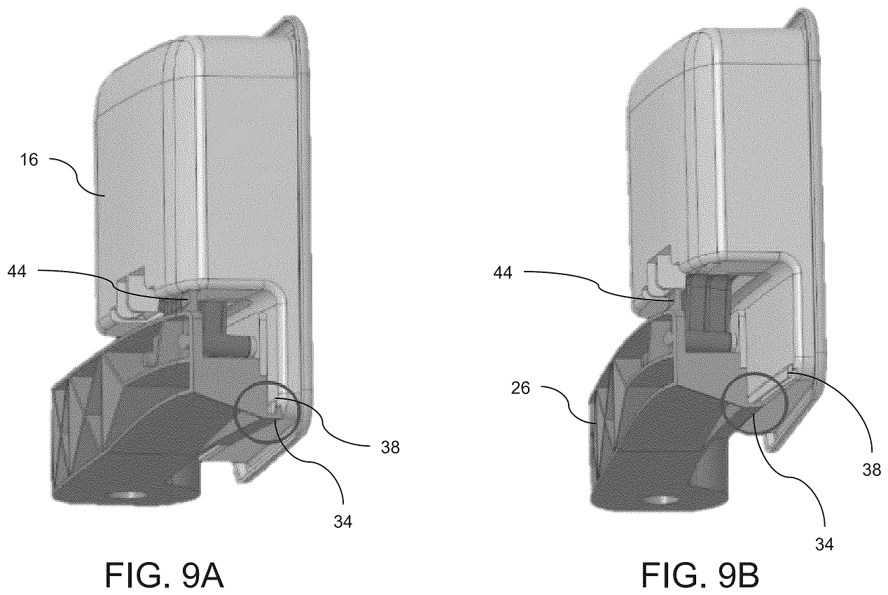

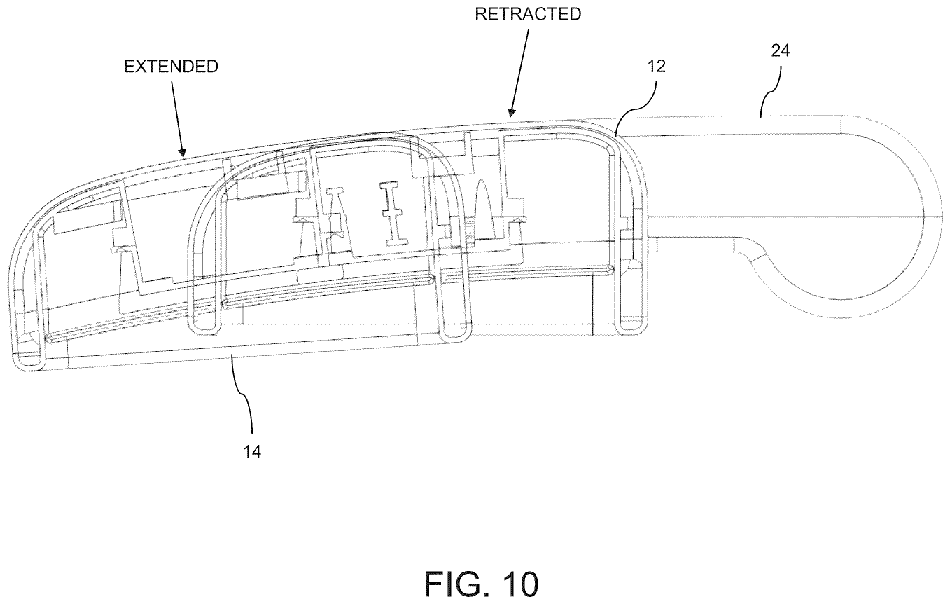

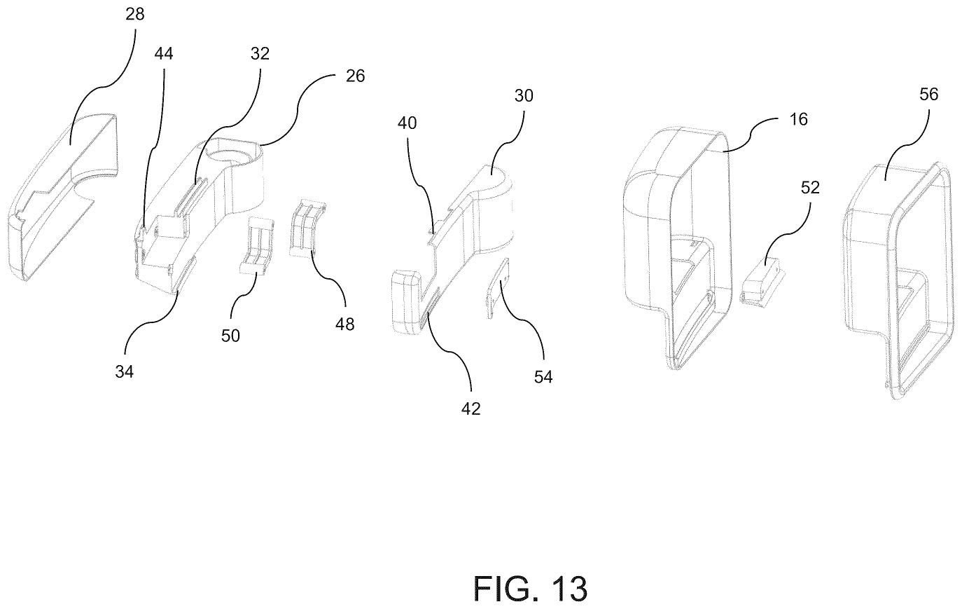

The mirror head 12 and the arm 24 include one or more guide members received along respective channels to direct movement of the mirror head 12 along the arm 24 between the retracted state and the extended state and to retain the mirror head at the retracted state or the extended state. In the illustrated example, the arm 24 includes a structural member or skeleton or inner portion 26 housed between a first cover portion 28 and a second cover portion 30. A first or upper channel 32 and a second or lower channel 34 are integrally formed with the structural member 26. When the mirror head 12 is disposed at the arm 24, a first or upper guide member 36 of the mirror head 12 is disposed along the upper channel 32 (FIGS. 8A and 8B) and a second or lower guide member 38 of the mirror head 12 is disposed along the lower channel 34 (FIGS. 9A and 9B). For example, the upper guide member 36 and the lower guide member 38 are integrally formed with the mirror housing or casing 16. The upper guide member 36 extends through a first or upper aperture or slot 40 formed between the first cover portion 28 and the second cover portion 30 to be received along the upper channel 32 and the lower guide member 38 extends through a second or lower aperture or slot 42 formed through the second cover portion 30 to be received along the lower channel 34 (FIG. 13). Further, a third guide member 44 may extend from the structural member 26 and be received along a third channel 46 formed at the mirror head 12 (FIGS. 8A and 8B). Optionally, one or more of the channels may be integrally formed with the mirror head and one or more of the guide members may be integrally formed with the arm 24. Thus, when the mirror head 12 is moved between the retracted state (FIGS. 3A, 4A, 5A, 6A, 8A and 9A) and the extended state (FIGS. 3B, 4B, 5B, 6B, 8B and 9B), the first guide member 36 moves along the first channel 32 (such as riding at least partially within the first channel and/or moving at least partially above and in a direction parallel to the first channel), the second guide member 38 moves along the second channel 34 (such as riding at least partially within the second channel and/or moving at least partially above and in a direction parallel to the second channel), and the third guide member 44 moves along the third channel 46 (such as the third guide member riding at least partially within the third channel and/or the third channel moving at least partially above the third guide member) to guide movement of the mirror head 12 relative to the arm 24 of the mounting structure 18.

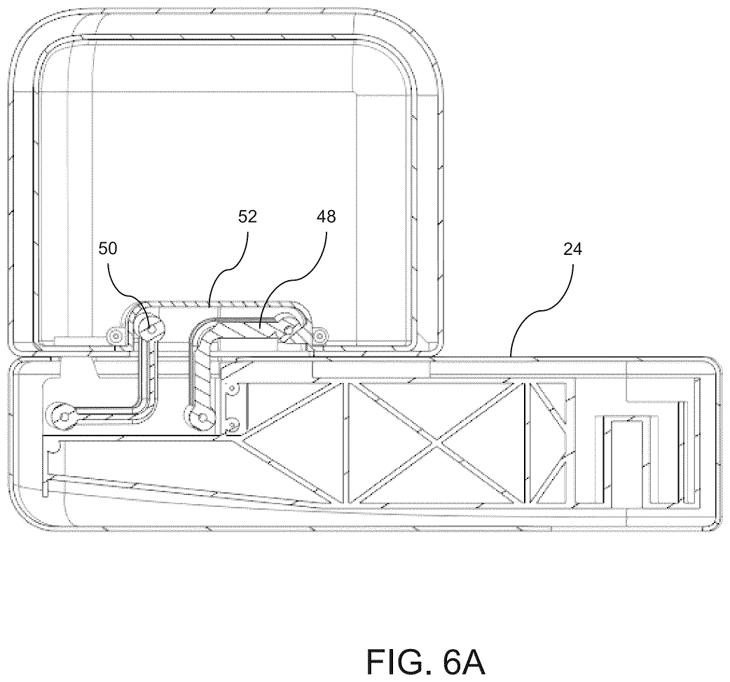

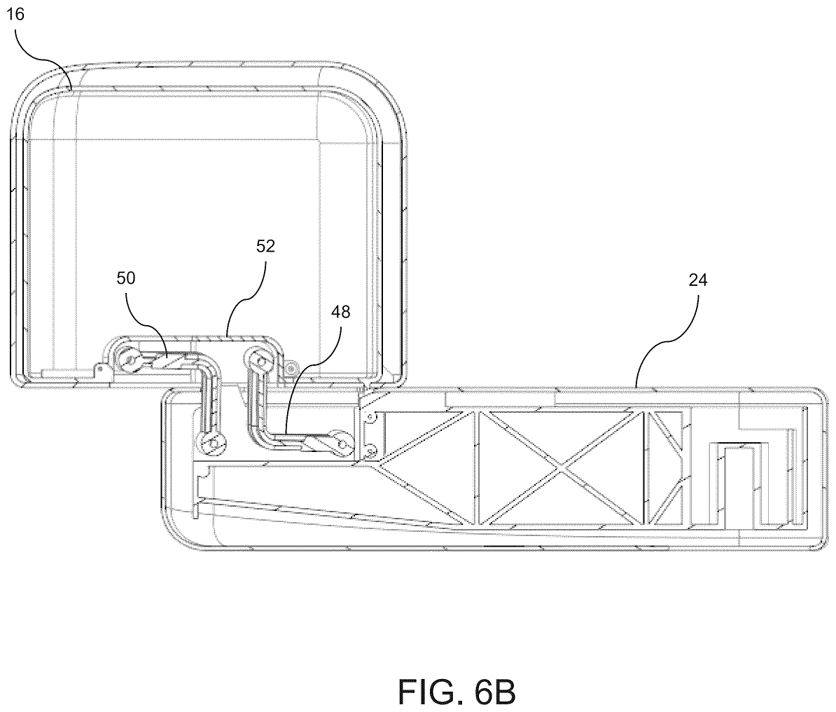

An electrically operable actuator (not shown) may be operable to move the mirror head 12 between the extended state and the retracted state and/or the mirror head 12 may be manually movable between the extended state and the retracted state. The adjustment mechanism 20 includes a first pivot link or arm 48 and a second pivot link or arm 50 that are each pivotally attached at one end to the structural member 26 and pivotally attached at other ends to the mirror head 12. For example, the respective first ends of the first pivot link 48 and the second pivot link 50 are pivotally attached to an upper link retainer 52 that attaches at the mirror casing 16 (FIGS. 6A and 6B). The respective second ends of the first pivot link 48 and the second pivot link 50 are pivotally attached between the structural member 26 and a lower link retainer 54 (FIGS. 4A and 4B). A bezel portion 56 may attach to the mirror casing 16 to retain the upper link retainer 52 and the lower link retainer 54 at the mirror head 12 (FIG. 13). Because the first pivot link 48 and the second pivot link 50 are both constrained to the upper link retainer 52 and the lower link retainer 54, the first pivot link 48 and the second pivot link 50 pivot together and in tandem with one another when the mirror head 12 is moved between the retracted state and the extended state.

The actuator may drive one or both of the links to move the mirror head 12 between the extended state and the retracted state. In some examples, the mirror head 12 may be manually movable between the extended state and the retracted state with pivoting of the pivot links guiding movement of the mirror head between the extended state and the retracted state.

When the mirror head 12 is moved between the retracted state and the extended state, the mirror head 12 moves relative to the arm 24 of the mounting structure 18 according to movement of the respective first ends of the pivot links relative to the second ends. Because the pivot links are generally L-shaped, pivoting the pivot links about the respective second ends (which are constrained relative to the arm 24 of the mounting structure 18) causes the first ends of the pivot links and the mirror head 12 to move at least partially vertically relative to the mounting arm 24 and horizontally along the mounting arm 24 when the mirror head 12 is moved between the retracted state and the extended state. That is, as the pivot links pivot at the respective second ends relative to the structural member 26 to move the mirror head 12 from the retracted state (FIG. 4A) to the extended state (FIG. 4B), the respective first ends of the pivot links and the mirror head 12 move at least partially upward relative to the arm 24 of the mounting structure 18 and along the longitudinal axis of the mounting arm 24 outboard of the side of the vehicle, and then the first ends of the pivot links and the mirror head 12 move at least partially downward toward the arm 24 and continue to move along the mounting arm 24 outboard of the side of the vehicle until the mirror head 12 is supported at or rests on the mounting arm in the extended state. When moving from the extended state to the retracted state, the first ends of the pivot links move at least partially upward relative to the arm 24 and along the mounting arm inboard toward the side of the vehicle, and then the first ends of the pivot links and the mirror head 12 move at least partially downward toward the arm 24 and continue to move along the mounting arm 24 inboard toward the side of the vehicle until the mirror head 12 is supported at or rests on the mounting arm in the retracted state.

The respective guide members and channels of the mounting structure 26 and mirror casing 16 may be configured to allow the mirror head 12 to at least partially lift away from the mounting arm 24 during movement between the retracted state and the extended state. In other words, the first guide member 36 may at least partially lift out of the first channel 32, the second guide member 38 may at least partially lift out of the second channel 34, and the third channel 46 may at least partially lift away from the third guide member 44. As the mirror head 12 approaches the extended state or retracted state, the respective guide members may move back into engagement with the respective channels.

For example, when the mirror head is in the extended state (FIGS. 8B and 9B), the guide member 44 of the mounting arm 24 is received at an inner part of the channel or recess 46 of the mirror head (and the channel 46 may include two channel portions, one at each side of the attaching region of the links at the mirror head), and the guide member 36 of the mirror head is at an outer end of the channel or recess 32 of the mounting arm 24, and the guide member 38 of the mirror head is received at an outer end of the channel or recess 34 of the mounting arm 24. As the mirror head swings from the extended state toward the retracted state, the guide members or channels of the mirror head move relative to the channels or guide members of the mounting arm and may partially or fully disengage. When the mirror head is in the retracted state (FIGS. 8A and 9A), the guide member 44 of the mounting arm is received at an outer part of the channel or recess 46 of the mirror head, and the guide member 36 of the mirror head is at an inner end of the channel or recess 32 of the mounting arm, and the guide member 38 of the mirror head is received at an inner end of the channel or recess 34 of the mounting arm (and the guide member 38 of the mirror head may be received further along the channel 34, such as fully along the channel 34 when the mirror head is in the retracted state). The guide members and channels thus function to limit fore/aft movement of the mirror head relative to the mounting arm to limit or preclude movement of the mirror head relative to the mounting arm due to wind load as the vehicle is driven along a road with the mirror head in either the retracted state or the extended state. The guide members and channels may remain partially engaged during swinging of the mirror head between the retracted state and the extended state to guide such movement and limit movement in the wind direction (generally along the longitudinal axis of the vehicle).

The guide members and/or channel members may be configured to guide the mirror head 12 back into alignment with the arm 24 of the mounting structure 18 at the extended and retracted states. For example, the guide members and/or channels may be tapered. Thus, engagement of the guide members and channels as the mirror head moves into the extended state or the retracted state may guide or align the mirror head into the desired position. Moreover, gravitational forces and the weight of the mirror head may help to hold the mirror head 12 in place in the extended state and the retracted state, which may reduce vibrations transferred between the mounting arm 24 and the mirror head 12 when the vehicle travels along the road.

Optionally, the adjustment mechanism may be configured so that the mirror head does not fully lift away from the mounting arm when the mirror head is moved between the retracted state and the extended state. That is, as the mirror head moves between the retracted state and the extended state, the mirror head moves along the mounting arm and the respective guide members do not fully lift out of the respective channels. This may retain positioning of the mirror head relative to the longitudinal axis of the mounting arm during movement between the retracted state and the extended state and prevent inadvertent misalignment of the respective guide members and channels when the mirror head arrives at the retracted state or extended state, such as due to the wind load at the mirror head.

Referring to FIGS. 10-12, when the mirror head 12 is moved between the extended state and the retracted state, an angle of the mirror head 12 relative to the arm 24 of the mounting structure 18 changes to generally maintain the field of view provided by the mirror reflective element 14. That is, when the mirror head 12 is moved from the retracted state to the extended state, the mirror head 12 is extended away from the side of the vehicle and pivoted at least partially in toward the side of the vehicle to provide generally the same view to the driver at the extended state as at the retracted state. Optionally, the angle of the mirror head relative to the side of the vehicle at the extended state may be configured to provide a different view to the driver as compared to the retracted state, such as a wider field of view extending further outboard from the side of the vehicle, such as to allow the driver to see further rearward of the vehicle when towing a trailer hitched to the vehicle.

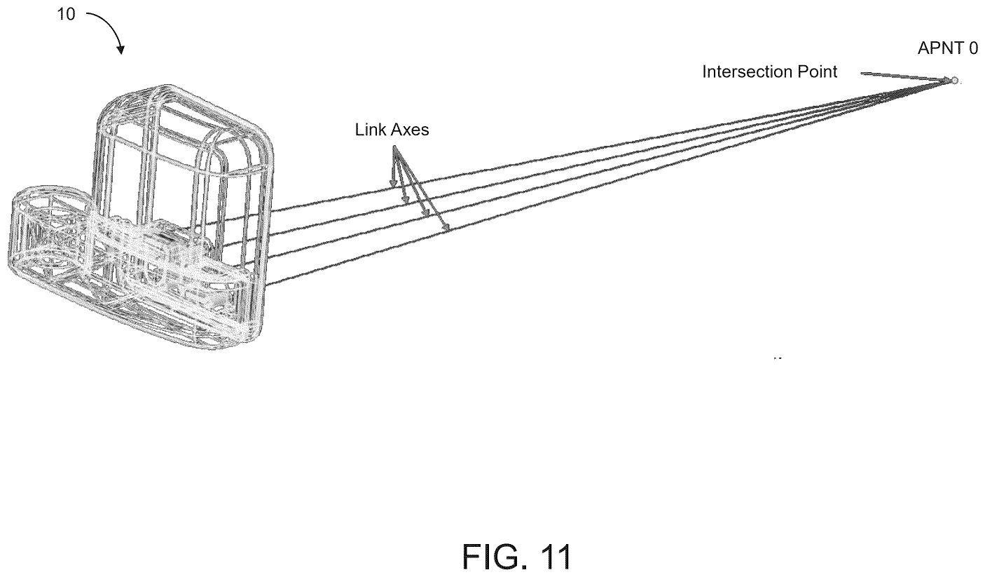

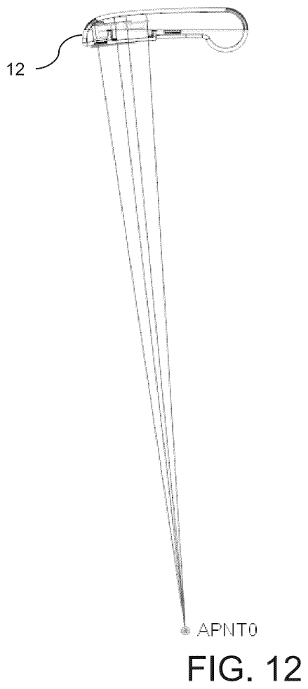

As shown in FIGS. 11 and 12, the pivot axes of the pivot links are angled relative to one another to intersect at a point generally rearward of the mirror assembly 10. That is, the first pivot link 48 and the second pivot link 50 are pivotally attached at the structural member 26 and the mirror casing 16 so that the pivot axis at the first end of the first pivot link 48, the pivot axis at the second end of the first pivot link 48, the pivot axis at the first end of the second pivot link 50, and the pivot axis at the second end of the second pivot link 52 are at oblique angles relative to one another and intersect at a common point. The intersection of the pivot axes is spaced from the mirror head and rearward of the mirror assembly (e.g., along the side of the vehicle and rearward of the mirror assembly). This causes the mirror head 12 to be rotated at least partially inward toward the side of the vehicle when extended to allow for head angle compensation between inboard and outboard positions and to avoid the need for the driver to readjust the angle of the mirror reflective element 14 relative to the mirror head 12. The relative head angle can be changed by changing the position of the intersection point.

The extendable and retractable mirror assembly may utilize characteristics of the mirror assemblies described in U.S. Pat. Nos. 11,845,383, 11,718,232, and/or U.S. Publication Nos. US-2023-0012333 and/or US-2023-0373392 and/or U.S. patent application Ser. No. 19/013,040, filed Jan. 8, 2025 (Attorney Docket DON09 P5305), which are hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mounting structure configured to mount the vehicular exterior rearview mirror assembly at a side of a vehicle;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position, where the mirror head is extended from the retracted position outward from the side of the vehicle to provide the rearward view to the driver of the vehicle;
wherein the mirror head is closer to the side of the vehicle at which the mounting structure is attached when in the retracted position as compared to the extended position;
an adjustment mechanism operable to guide movement of the mirror head relative to the mounting structure between the retracted position and the extended position;
wherein the adjustment mechanism comprises a pivot link, and wherein the pivot link comprises (i) a first end pivotally attached at the mirror head and (ii) a second end pivotally attached at the mounting structure; and
wherein, with the vehicular exterior rearview mirror assembly mounted at the side of the vehicle, and when the mirror head moves from the retracted position toward the extended position, (a) the second end of the pivot link pivots relative to the mounting structure, (b) the first end of the pivot link pivots relative to the mirror head and (c) the first end of the pivot link moves with the mirror head (i) at least partially in a direction away from the side of the vehicle and (ii) at least partially vertically relative to the mounting structure.

2. The vehicular exterior rearview mirror assembly of claim 1, wherein the pivot link comprises an inboard pivot link and an outboard pivot link, and wherein the inboard pivot link and the outboard pivot link pivot together and in tandem with one another when the mirror head moves between the retracted position and the extended position.

3. The vehicular exterior rearview mirror assembly of claim 2, wherein respective first ends and respective second ends of the inboard pivot link and the outboard pivot link define respective pivot axes, and wherein each of the respective pivot axes are at oblique angles relative to one another.

4. The vehicular exterior rearview mirror assembly of claim 3, wherein each of the respective pivot axes intersect one another at a common intersection point in space.

5. The vehicular exterior rearview mirror assembly of claim 1, wherein the first end of the pivot link defines a pivot axis, and wherein, when the mirror head moves between the retracted position and the extended position, the mirror head moves with the first end of the pivot link and about the pivot axis, and wherein, with the vehicular exterior rearview mirror assembly mounted at the side of the vehicle, the pivot axis is parallel to a longitudinal axis of the vehicle.

6. The vehicular exterior rearview mirror assembly of claim 1, wherein the mounting structure comprises a channel and the mirror head comprises a guide member, and wherein, with the mirror head positioned at one selected from the group consisting of the retracted position and the extended position, the guide member is received at least partially within the channel to retain the mirror head relative to the mounting structure.

7. The vehicular exterior rearview mirror assembly of claim 6, wherein, when the mirror head moves from the one selected from the group consisting of the retracted position and the extended position, the mirror head at least partially lifts relative to the mounting structure and the guide member lifts fully out of the channel and the mirror head moves toward the other selected from the group consisting of the retracted position and the extended position.

8. The vehicular exterior rearview mirror assembly of claim 6, wherein, when the mirror head moves from the one selected from the group consisting of the retracted position and the extended position, the guide member moves within the channel and does not lift fully out of the channel.

9. The vehicular exterior rearview mirror assembly of claim 1, wherein, with the vehicular exterior rearview mirror assembly mounted at the side of the vehicle, and when the mirror head moves from the extended position toward the retracted position, the first end of the pivot link moves with the mirror head (i) at least partially in a direction toward the side of the vehicle and (ii) at least partially vertically relative to the mounting structure.

10. The vehicular exterior rearview mirror assembly of claim 1, wherein, with the vehicular exterior rearview mirror assembly mounted at the side of the vehicle, and when the mirror head moves between the extended position and the retracted position, the mirror head moves at least partially above the mounting structure.

11. The vehicular exterior rearview mirror assembly of claim 1, wherein, with the vehicular exterior rearview mirror assembly mounted at the side of the vehicle, and when the mirror head moves between the retracted position and the extended position, the first end of the pivot link moves with the mirror head and at least partially in a direction parallel to a longitudinal axis of the mounting structure.

12. The vehicular exterior rearview mirror assembly of claim 1, wherein the adjustment mechanism comprises an actuator, and wherein the actuator is electrically operable to drive the pivot link to move the mirror head between the retracted position and the extended position.

13. The vehicular exterior rearview mirror assembly of claim 12, wherein the adjustment mechanism operates the actuator to move the mirror head in response to a user input disposed in the vehicle, and wherein the user input is actuatable by the driver of the vehicle.

14. A vehicular exterior rearview mirror assembly, the vehicular exterior rearview mirror assembly comprising:
a mounting structure configured to mount the vehicular exterior rearview mirror assembly at a side of a vehicle;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position, where the mirror head is extended from the retracted position outward from the side of the vehicle to provide the rearward view to the driver of the vehicle;
wherein the mirror head is closer to the side of the vehicle at which the mounting structure is attached when in the retracted position as compared to the extended position;
wherein the mounting structure comprises a channel and the mirror head comprises a guide member, and wherein, with the mirror head positioned at one selected from the group consisting of the retracted position and the extended position, the guide member is received at least partially within the channel to retain the mirror head relative to the mounting structure;
an adjustment mechanism operable to guide movement of the mirror head relative to the mounting structure between the retracted position and the extended position;
wherein the adjustment mechanism comprises a pivot link, and wherein the pivot link comprises (i) a first end pivotally attached at the mirror head and (ii) a second end pivotally attached at the mounting structure;
wherein, with the vehicular exterior rearview mirror assembly mounted at the side of the vehicle, and when the mirror head moves from the retracted position toward the extended position, (a) the second end of the pivot link pivots relative to the mounting structure, (b) the first end of the pivot link pivots relative to the mirror head and (c) the first end of the pivot link moves with the mirror head (i) at least partially in a direction away from the side of the vehicle and (ii) at least partially vertically relative to the mounting structure; and
wherein, with the vehicular exterior rearview mirror assembly mounted at the side of the vehicle, and when the mirror head moves from the extended position toward the retracted position, (a) the second end of the pivot link pivots relative to the mounting structure, (b) the first end of the pivot link pivots relative to the mirror head and (c) the first end of the pivot link moves with the mirror head (i) at least partially in a direction toward the side of the vehicle and (ii) at least partially vertically relative to the mounting structure.

15. The vehicular exterior rearview mirror assembly of claim 14, wherein, when the mirror head moves from the one selected from the group consisting of the retracted position and the extended position, the mirror head at least partially lifts relative to the mounting structure and the guide member lifts fully out of the channel and the mirror head moves toward the other selected from the group consisting of the retracted position and the extended position.

16. The vehicular exterior rearview mirror assembly of claim 14, wherein, when the mirror head moves from the one selected from the group consisting of the retracted position and the extended position, the guide member moves within the channel and does not lift fully out of the channel.

17. The vehicular exterior rearview mirror assembly of claim 14, wherein the adjustment mechanism comprises an actuator, and wherein the actuator is electrically operable to drive the pivot link to move the mirror head between the retracted position and the extended position.

18. A vehicular exterior rearview mirror assembly, the vehicular exterior rearview mirror assembly comprising:
a mounting structure configured to mount the vehicular exterior rearview mirror assembly at a side of a vehicle;
a mirror head accommodating a mirror reflective element;
wherein, with the vehicular exterior rearview mirror assembly mounted at the side of the vehicle, the mirror head is movable relative to the mounting structure between (i) a retracted position where the mirror head is positioned at the side of the vehicle so that the mirror reflective element provides a rearward view to a driver of the vehicle that is at least rearward and along the side of the vehicle and (ii) an extended position, where the mirror head is extended from the retracted position outward from the side of the vehicle to provide the rearward view to the driver of the vehicle;
wherein the mirror head is closer to the side of the vehicle at which the mounting structure is attached when in the retracted position as compared to the extended position;
an adjustment mechanism operable to guide movement of the mirror head relative to the mounting structure between the retracted position and the extended position;
wherein the adjustment mechanism comprises a pair of pivot links, and wherein the pair of pivot links comprises an inboard pivot link and an outboard pivot link, and wherein the inboard pivot link and the outboard pivot link pivot together and in tandem with one another when the mirror head moves between the retracted position and the extended position, and wherein each of the inboard pivot link and the outboard pivot link comprises (i) a first end pivotally attached at the mirror head and (ii) a second end pivotally attached at the mounting structure;
wherein the adjustment mechanism comprises an actuator, and wherein the actuator is electrically operable to drive at least one selected from the group consisting of the inboard pivot link and the outboard pivot link to move the mirror head between the retracted position and the extended position; and
wherein, with the vehicular exterior rearview mirror assembly mounted at the side of the vehicle, and when the mirror head moves from the retracted position toward the extended position, (a) the second ends of the pivot links pivot relative to the mounting structure, (b) the first ends of the pivot links pivot relative to the mirror head and (c) the first ends of the pivot links move with the mirror head (i) at least partially in a direction away from the side of the vehicle and (ii) at least partially vertically relative to the mounting structure.

19. The vehicular exterior rearview mirror assembly of claim 18, wherein the respective first ends and respective second ends of the inboard pivot link and the outboard pivot link define respective pivot axes, and wherein each of the respective pivot axes are at oblique angles relative to one another, and wherein each of the respective pivot axes intersect one another at a common intersection point in space.

20. The vehicular exterior rearview mirror assembly of claim 18, wherein the mounting structure comprises a channel and the mirror head comprises a guide member, and wherein, with the mirror head positioned at one selected from the group consisting of the retracted position and the extended position, the guide member is received at least partially within the channel to retain the mirror head relative to the mounting structure.
